(19) United States
(12) Patent Application Publication
(10) Pub. No.: US 2017/0262160 A1
(43) Pub. Date: Sep. 14, 2017

(54) METHOD AND APPARATUS FOR PROVIDING A MULTI-PANE GRAPHICAL DISPLAY WITH INFORMATION ASSOCIATED WITH A CASE DATA STRUCTURE

(71) Applicant: General Electric Company, Schenectady, NY (US)

(72) Inventor: David Sean Farrell, Lisle, IL (US)

(21) Appl. No.: 15/068,947

(22) Filed: Mar. 14, 2016

(51) Int. Cl. G06F 3/0484; G06F 3/0482; G06F 17/30; G06F 3/0488; H04L 29/08

(52) U.S. Cl. CPC G06F 3/04842; G06F 3/0488; H04L 67/025; G06F 17/30321; G06F 3/0482

(57) ABSTRACT

Approaches are provided for an apparatus having an interface with an input and an output. The apparatus also includes a display device having a touch-sensitive user interface. The apparatus also includes a processor coupled to the interface and the display device. The processor is configured to display at the display device a first content pane, a second content pane, and a third content pane. The first content pane includes a case report received at the input of the interface. The case report represents characteristics of a case associated with an abnormality detected in an industrial machine or system. The second content pane includes a user input interface configured to receive a user input. The third content pane includes a response to the user input. The response is received at the input of the interface.

### BACKGROUND

Technical Field

The subject matter disclosed herein generally relates to providing information associated with case data structures. More specifically, the subject matter relates to providing a graphical display having a multi-pane interface to display information from case data structure associated with a problematic industrial machine or system.

Brief Description of the Related Art

In industrial operations, industrial machines and systems are monitored to ensure proper operation and/or detect anomalies which may arise. Remote Monitoring & Diagnostic (M&D) approaches often include personnel at one location communicating with personnel at an operating site located at a separate, geographically remote location. The M&D personnel view information related to industrial machines or systems located at the operating site.

During operation, problems oftentimes occur which may warrant an operator or maintenance engineer's involvement. Using information related to the industrial machine or system, M&D personnel provide recommendations to personnel at the operating site.

At the operating site, operators review recommendations provided by M&D personnel. However, operators often are not provided with an indication of the reasoning behind the M&D personnel's recommendation. In some instances, this lack of information results in operators failing to implement the provided recommendation.

The above-mentioned problems have resulted in some user dissatisfaction with previous approaches, inefficient case resolution, and sub-optimal application of remote monitoring and diagnostic approaches.

### BRIEF DESCRIPTION OF THE DISCLOSURE

The approaches described herein provide for methods and apparatuses for providing a multi-pane graphical display with information associated with a case data structure. In many of these embodiments, an apparatus includes a network interface with an input and an output. The apparatus also includes a display device which may be comprised of a touch-sensitive user interface.

The apparatus also includes a processor coupled to the network interface and the display device. The processor is configured to display at the display device a first content pane, a second content pane, and a third content pane. This allows a user to evaluate the plurality of content panes in order to identify a course of action associated with the abnormality detected in the industrial machine or system.

The first content pane comprises a case report received at the input of the network interface. The case report representing characteristics of a case associated with an abnormality detected in an industrial machine or system.

The second content pane comprises a user input interface configured to receive a user input. In some approaches, the user input is a free-form text entry. In other approaches, the user input is an audio entry. In still other approaches, the user input is a video entry. In other approaches, the user input is selected from a predefined list of user inputs. The processor is configured to transmit the user input to a central computing device at a central location.

The third content pane comprises a response to the user input. The response is received at the input of the network interface. In some approaches, the processor is configured to display at the display device fourth content pane. The fourth content pane comprises a timeline. The timeline is received at the input of the network interface.

In some approaches, the plurality of content panes are defined by a display width and a display height. At least one of the display width and the display height of at least one of the plurality of content panes is configured to be modified by a user input at the touch-sensitive user interface of the display device.

In many of these embodiments, a method includes storing a case data structure in a memory device. In some aspects, the case data structure is stored in a memory device at a central computing device at a central location. In other aspects, the case data structure is stored in a memory device at a remote data center. The case data structure represents characteristics of a case associated with an abnormality detected in an industrial machine or system. The case data structure comprising one or more case content fields.

The method further includes displaying, at a user interface of a remote display device, a plurality of content panes. In this way, a user is able to evaluate the plurality of content panes in order to identify a course of action associated with the abnormality detected in the industrial machine or system.

The method further includes displaying, at a first content pane, a case report indicative of at least one of the case content fields. The method further includes displaying, at a second content pane, a user input interface configured to receive a user input. The method further includes displaying, at a third content pane, a response to the user input. In some approaches, the method further includes displaying, at a fourth content pane, a timeline corresponding to the case data structure.

In some aspects, the method further includes receiving a user input from the remote display device. The user input may be, for example, at least one of an audio input, a video input, a free-form text input, or a selected user input selected from a predefined list of user inputs. In some approaches, in response to receiving the user input from the remote display device, the method further includes transmitting a response to the user input to the remote display device.

In some approaches, the method further includes displaying the plurality of content panes at user interfaces of a plurality of remote display devices.

### BRIEF DESCRIPTION OF THE DRAWINGS

For a more complete understanding of the disclosure, reference should be made to the following detailed description and accompanying drawings wherein:

FIG. 1 comprises an illustration of an informational flow chart for providing information relating to industrial machines or systems according to various embodiments of the present invention;

FIG. 2 comprises a block diagram illustrating an exemplary case data structure for managing information relating to industrial machines or systems according to various embodiments of the present invention;

FIG. 3 comprises a block diagram illustrating an exemplary apparatus for displaying information relating to industrial machines or systems according to various embodiments of the present invention;

FIG. 4 comprises an exemplary apparatus for displaying information relating to industrial machines or systems according to various embodiments of the present invention;

FIG. 5 comprises exemplary display of information relating to industrial machines or systems according to various embodiments of the present invention;

FIG. 6 comprises exemplary display of information relating to industrial machines or systems according to various embodiments of the present invention;

FIG. 7 comprises exemplary display of information relating to industrial machines or systems according to various embodiments of the present invention;

FIG. 8 comprises exemplary display of information relating to industrial machines or systems according to various embodiments of the present invention;

FIG. 9 comprises exemplary display of information relating to industrial machines or systems according to various embodiments of the present invention; and

FIG. 10 comprises an operational flow chart illustrating an approach for case management according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE DISCLOSURE

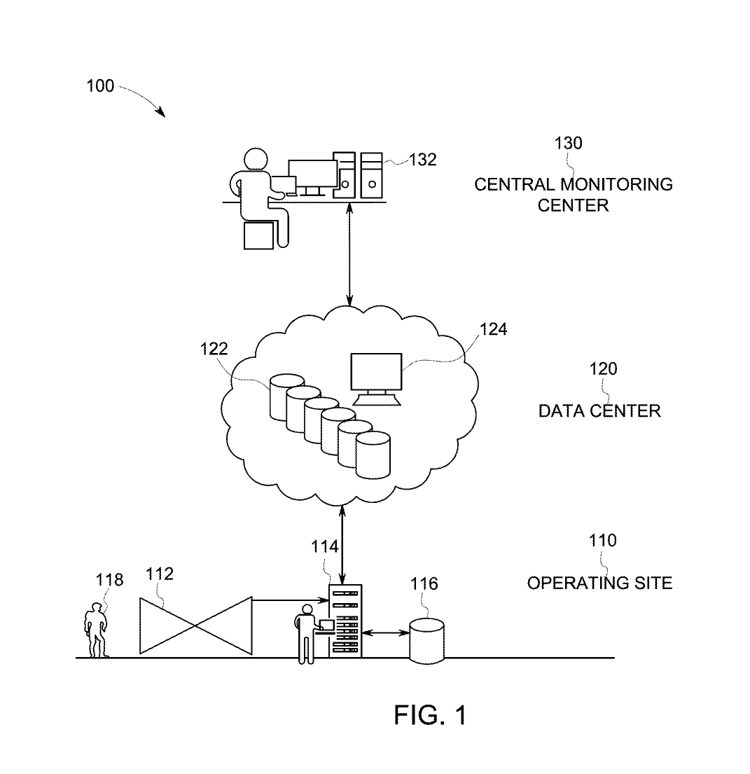

Referring now to FIG. 1, a system 100 for monitoring industrial machines includes an operating site 110, optionally, a data center 120, and a central monitoring center 130. The operating site 110 includes one or more industrial machines, equipment, or systems of industrial machines or equipment 112. Examples of industrial machines 112 monitored in system 100 include aircraft machinery (e.g., turbine engines), marine machinery, mining machinery, oil machinery, gas machinery, health care machinery, telecom machinery, to mention a few examples. Other examples are possible.

Industrial machine 112 is operably connected to a local computing device 114 such that the computing device 114 receives or obtains information from the industrial machine 112. The computing device 114 may be continuously connected to the industrial machine 112, or may be removably connected to the industrial machine 112. In one approach, the computing device 114 is located at the operating site 110. In other approaches, the computing device 114 is instead located remotely from the industrial machine 112.

Information received at the computing device 114 from the industrial machine 112 includes operational characteristics of the industrial machine 112. Operational characteristics may include a measured temperature, a measured vibration, a measured pressured, a calculated efficiency, a structural defect, a lifespan of machine, a machine history, and/or a detected position shift. Other examples are possible.

The computing device 114 may be any type of hardware device such as a personal computer, a tablet, a cellular telephone, and/or a personal digital assistant. Other examples are possible. The computing device 114 may include a processor, an interface (e.g., a computer based program and/or hardware) having an input (which may also include a user input) and an output, a memory, and a display device (e.g., a screen or a graphical user interface which allows for a visualization to be made). In this way, a user of the computing device 114 is able to observe information at the computing device 114 (such as operational characteristics of the industrial machine 112), input information into the computing device 114, send information from the computing device 114 to a remote device (such as at the data center 120 or the central monitoring center 130), and receive information from a remote device. The computer device 114 may be configured to run specific software applications, such as a historian.

The computing device 114 is operably connected to a data storage module 116. The data storage module 116 includes a memory for short- and/or long-term storage of information received from the computing device 114. Examples of information received and stored at the data storage module 116 include historical information relating to the industrial machine 112, or information received at the computing device from a remote device (such as at the data center 120 or the central monitoring center 130).

Personnel at the operating site 110 can observe information pertaining to the industrial machine 112 on one or more personal computing devices 118. The personal computing devices can connect to and receive data from other computing devices located at the operating site 110 (e.g., computing device 114), the data center 120, and/or the central monitoring center 130.

The personal computing devices 118 may include, for example, a desktop computer, a laptop computer, a portable tablet, or a mobile phone located at the operating site 110. Other examples are possible. In this way, through personal computing devices 118, on-site personnel at the operating site 110 can receive and review information pertaining to the industrial machine 112 in a convenient manner. Furthermore, personnel at the operating site 110 can efficiently communicate with personnel at the central monitoring center 130.

The optional data center 120 is in communication with the operating site 110 (preferably, with the computing device 114 at the operating site) such that the data center 120 can send and/or receive information pertaining to one or more industrial machines 112 located at the operating site 110. The data center 120 maybe located at the operating site 110, at the central monitoring center 130, or in a location geographically remote from the operating site 110 and the central monitoring center 130. In one approach, the data center 120 is disposed on a cloud based network.

The data center 120 includes one or more data storage modules 122 having corresponding memories. The data center 120 may also include one or more computing devices 124 that include a processor, an interface having an input (which may include a user input) and an output, a memory, and a display device (e.g., a screen or a graphical user interface which allows for a visualization to be made). Various applications may be performed at the data center 120, including analytic modeling, anomaly detection, and/or calculations of key performance indicators.

The central monitoring center 130 includes a computing device 132 that is in communication with the data center 120 such that the central monitoring center 130 can send and/or receive information pertaining to one or more industrial machines 112 located at the operating site 110. Alternatively, the central monitoring center 130 is in communication with the operating site 110 (preferably, with the computing device 114 at the operating site) such that the central monitoring center 130 can send and/or receive information pertaining to one or more industrial machines 112 located at the operating site 110.

In the operation of the system 100 of FIG. 1, personnel located at the operating site 110 are frequently in communication with personnel at the central monitoring center 130. In one example, personnel at the operating site initiate communication with personnel at the central monitoring center 130. For example, a maintenance technician at an operating site 110 such as an offshore oil platform may inquire about a given pump located on the oil platform. In many instances, the technician's question is best suited for personnel at the central monitoring center 130.

In another example of the operation of the system 100 of FIG. 1, when an anomaly, abnormality, or incident is detected in an industrial machine or system (such as machine 112 of FIG. 1), personnel at the central monitoring center 130 collect information from the operating site 110. The collected information is stored in a case data structure (or combination of case data structures) associated with the case. As used herein, a “case” is associated with an anomaly, an abnormality, or an incident detected in an industrial machine or system, and a “case data structure” includes a data structure that represents a compilation of characteristics of the case. The case data structure may include, for example, an evidence field with evidence (e.g., a characteristic associated with the industrial machine or system), an interpretation field with an interpretation (e.g., a user determined condition based at least in part on the evidence), and a recommendation field with a recommendation (e.g., a user determined course of action to undertake with respect to the industrial machine or system based at least in part on the interpretation). Personnel at the operating site 110 or the central monitoring center 130 may link evidence, expert interpretation associated with the evidence, metadata describing the particular nature of the industrial machine at issue, and/or other relevant information to the case data structure. Based at least in part on the information stored in the case data structure, personnel at the central monitoring center 130 may provide recommendations to personnel at the operating site 110.

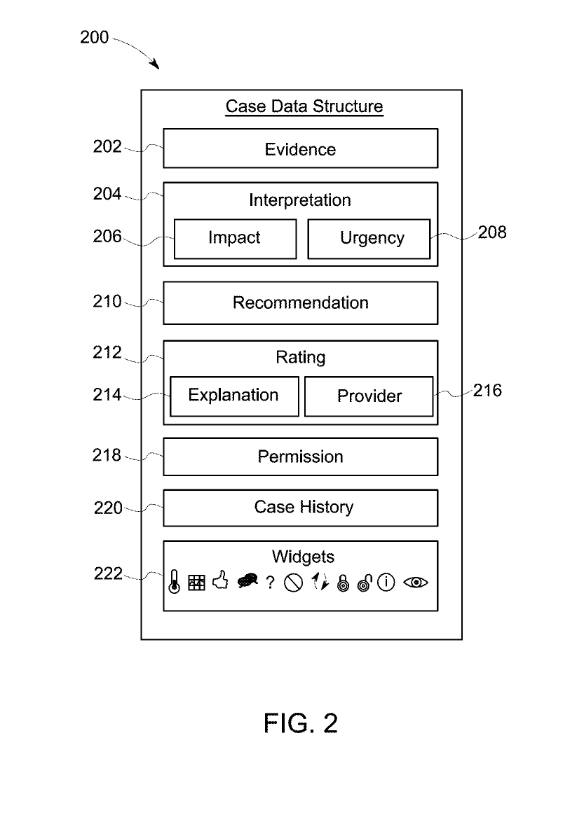

An example case data structure 200 is shown in FIG. 2. The case data structure represents 200 characteristics of a case associated with an abnormality detected in an industrial machine or system. The case data structure 200 may include an evidence field 202 with evidence. The evidence includes information associated with the anomaly and/or the industrial machine 112. For example, the evidence associated with the industrial machine or system may include: a measured temperature, a measured vibration, a measured pressured, a calculated efficiency, a structural defect, a lifespan of machine, a machine history, and/or a detected position shift. The evidence may be in the form of advisories, alarms, charts, or reports.

The case data structure 200 also includes an interpretation field 204 with one or more interpretations. The interpretation includes a user determined condition based at least in part on the evidence. For example, the interpretation may be: a case diagnosis, a case prognosis, a case impact, and/or a case urgency.

The interpretation field 204 further includes an impact field 206 for storing an impact value. The impact value provides an indication of a potential harm posed by the abnormality detected in the industrial machine or system 112. For example, an assessed impact associated with a problematic machine on an oil platform may be a given number of barrels of lost production. If the number of barrels of lost production is relatively minor, the impact field is assigned a low impact value. Conversely, if the number of barrels of lost production is relatively major, the impact field is assigned a high impact value.

The interpretation field 204 further includes an urgency field 208 for storing an urgency value. The urgency value is an indication of timing associated with the potential harm posed by the abnormality detected in the industrial machine or system. In some approaches, the urgency value is an indication of how soon an analyst determines the abnormality should be addressed. In other approaches, the urgency value is an indication of how soon the harm posed by an abnormality is expected to occur. For example, if the expected lost production for an oil platform is anticipated to occur in the relatively near future, the urgency field is assigned a first urgency value indicative of this timing. If the expected lost production is anticipated to occur in the relatively distant future, the urgency field is assigned a second urgency value indicative of this timing.

The case data structure 200 may also include a recommendation field 210, a rating field 212 (which may further include a rating explanation field 214 and/or a rating provider field 216), a permission field 218, a case history field 220, and/or one or more widgets 222.

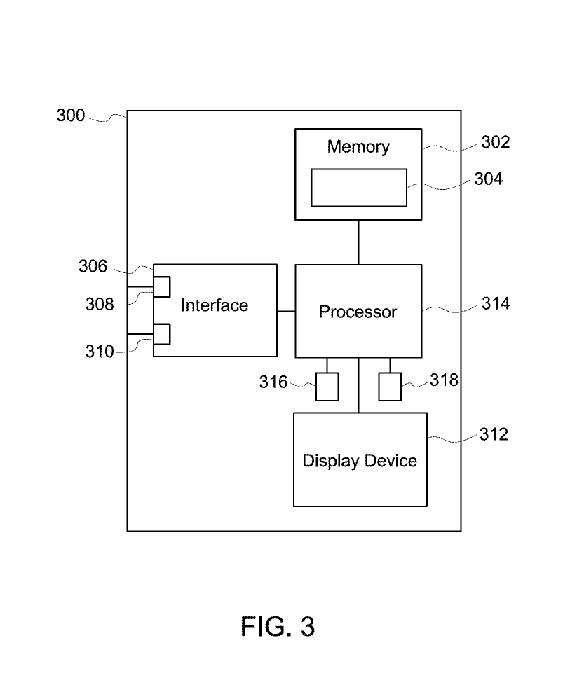

In some aspects, assessment and resolution of a case may be improved through efficient communication between on-site personnel located at the operating site (e.g., operating site 110) and personnel located at a remote monitoring center (e.g. central monitoring center 130). In this regard, with reference to FIG. 3, an apparatus 300 (such as personal computing device 118 of FIG. 1) includes a memory device 302. The memory may be any suitable type of memory, including volatile or nonvolatile memories such as random access memory (RAM), dynamic RAM (DRAM), synchronous RAM (SRAM), read only memory (ROM), programmable ROM (PROM), erasable PROM (EPROM), electrically erasable PROM (EEPROM), non-volatile RAM (NVRAM), flash memory, solid state drives (SSD), embedded Multi-Media Card (eMMC).

The memory device 302 stores a case data structure 304 (or one or more case content fields associated with a case data structure). As discussed with respect to the case data structure 200 of FIG. 2, the case data structure 304 represents characteristics of a case associated with an abnormality detected in the industrial machine or system.

The apparatus 300 further includes a network interface 306 configured to connect to a wired or wireless network. The network interface 306 includes an input 308 and an output 310. The input 308 and output 310 are configured to receive and transmit, respectively, information from other computing devices (e.g., computing device 114 at the operating site 110, computing devices 124 at the data center 120, and/or computing devices 132 at the central monitoring center 130 of FIG. 1).

The apparatus 300 also includes a display device 312 configured to convey information to a user. The display device 312 may be a liquid crystal display screen, a light-emitting diode backlit liquid crystal display screen, or other screen capable of conveying information.

The display device 312 preferably includes a user input interface configured to receive a user input. In one approach, user input is provided through a user input interface in the form of a touch-sensitive display screen. In another approach, user input is provided through a user input interface in the form of a button, a keypad, or a touch-sensitive local surface responsive to a user's touch. In this manner, the same interface that conveys information to a user can also receive a user input. The display device 312 is operatively coupled to the input 308 so as to convey a user input to the network interface 306.

The apparatus 300 includes a processor 314 coupled to the memory device 302, the interface 308, and the display device 312. The processor 314 is configured to display a plurality of content panes at the display device 312. The content panes, discussed in greater detail elsewhere herein, are graphical windows or sub-windows defined by pane boundaries.

In some approaches, the apparatus 300 also includes a microphone 316 connected to the interface 308. The microphone 316 may be any suitable microphone capable of receiving audio from the proximity of the apparatus 300. In still other approaches, the apparatus 300 also includes a camera 318 connected to the interface 308. The camera 318 may be any suitable camera capable of capturing still images and or streaming video.

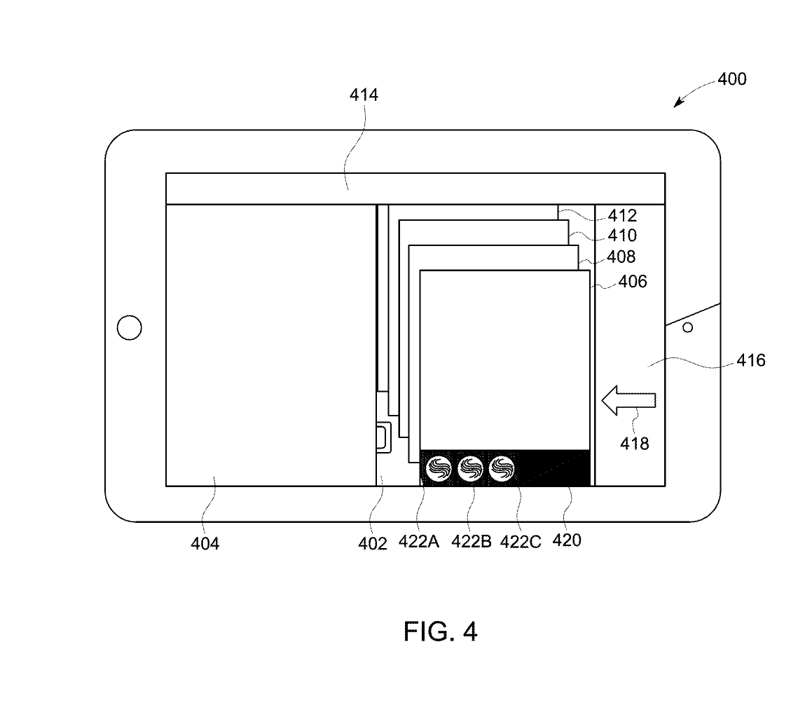

Referring now to FIG. 4, an apparatus 400 includes a display screen 402. The apparatus 400 is configured to display on the display screen 402 a plurality of content panes (e.g., content panes 404, 406, 408, 410, 412, 414, 416). The content panes are displayed in a layout and can be opened, closed, selected, deselected, maximized, minimized, resized, reordered, and/or rearranged. Control of the content panes is preferably performed through user gestures on a touch-sensitive surface of the display device 402. The gestures may include “tap” to select, “pinch” and “stretch” to zoom, and “swipe” to move or scroll the content panes.

In some aspects, a content pane (e.g., content pane 416) can be requested by a user through a user input such as a swipe along the surface of the display device 402 (indicated by arrow 418). In still other approaches, a content pane such as a virtual keyboard (not shown) can be presented to a user in order to allow the user to enter text.

Other navigation options are available. For example, a navigation bar 420 may be provided to allow a user to select a desired content pane for display. The navigation bar 420 may include, for example, a plurality of icons 422a, 422b, 422c, each associated with a content pane. Upon user selection of an icon, the associated content pane is displayed on the display device 402.

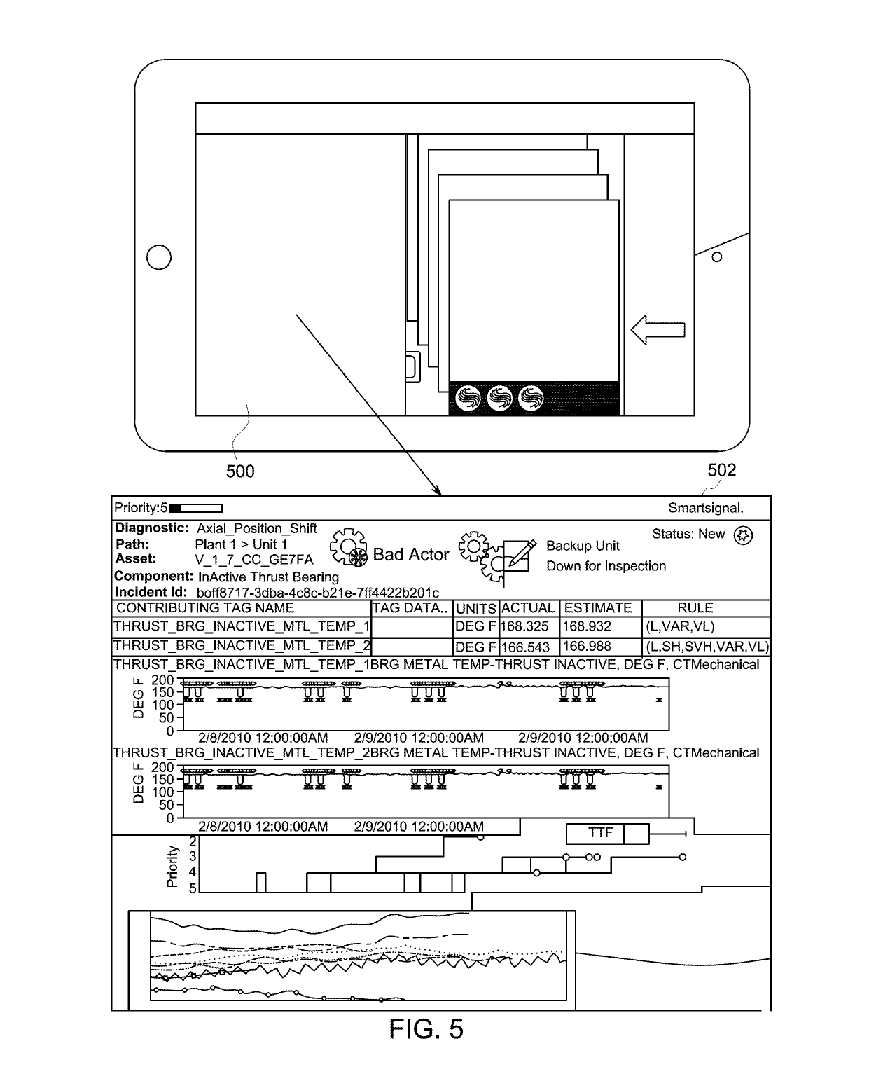

In some approaches, referring now to FIG. 5, a content pane 500 includes a case report 502. The case report 502 is indicative of at least one of the case content fields of a case data structure associated with an anomaly, an abnormality, or an incident detected in an industrial machine or system. The case report 502 may also include information pertaining to past actions associated with the industrial machine or system. Using this information, a user viewing the case report 502 is able to efficiently assess the case.

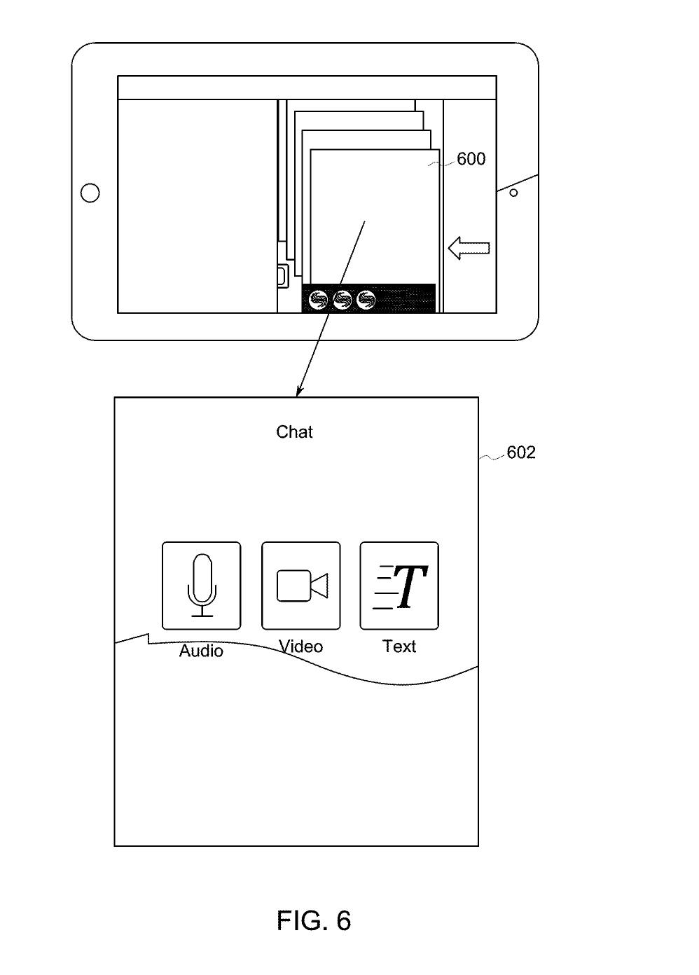

Referring now to FIG. 6, another content pane 600 includes a communication interface 602 that enables communication between on-site personnel (e.g., personnel at operating site 110) and remote personnel (e.g., personnel at central monitoring center 130). The communication may be initiated by on-site personnel or remote personnel. The communication interface 602 preferably presents a user with various user input options, such as an audio entry, a video entry, and/or free-form text entry. In this way, on-site personnel can efficiently communicate directly with personnel at a remote location through an “ask and receive” interface. For example, on-site personnel may inquire whether a given pump on an offshore oil platform typically operates a certain way during a prolonged period of abnormally hot weather.

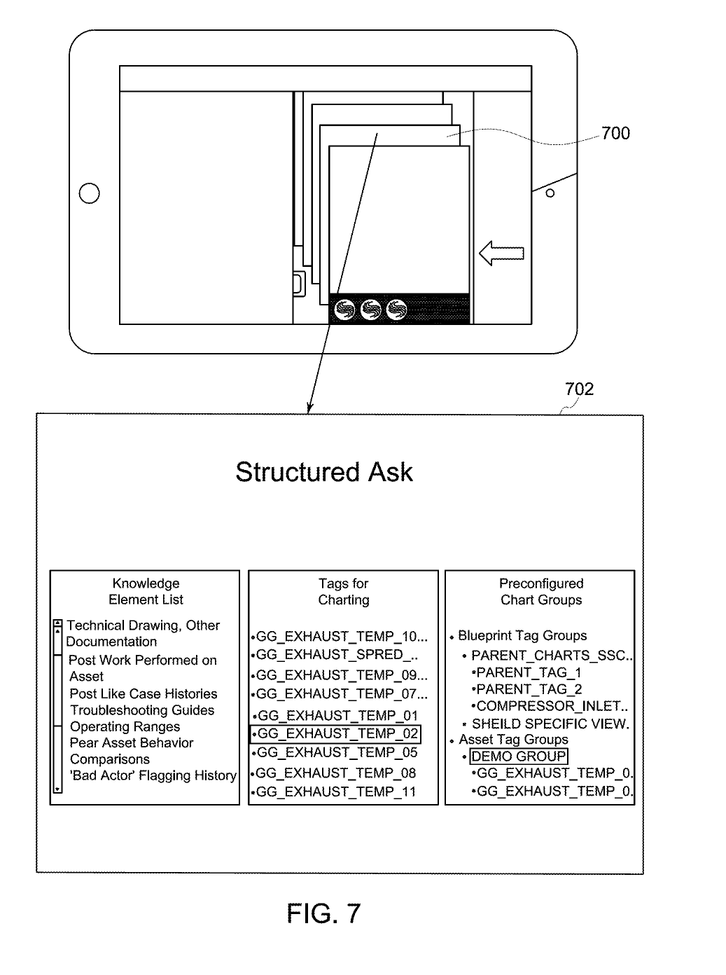

Referring now to FIG. 7, another content pane 700 includes an inquiry interface 702. The inquiry interface 702 presents a user with a prepopulated or predefined list of inquiries for ‘self-service’ to obtain insights augmenting the case report. For example, through the inquiry interface 702, a user may request technical drawings or other documentation pertaining to a given industrial machine, past work performed on the machine, past “like case” histories, troubleshooting guides, operating ranges, peer asset behavior comparisons, or “bad actor” flagging histories.

The inquiries provided by a user to the either a communication interface 602 or an inquiry interface 702 are transmitted to a computing device a remote location (such as computing device 124 at a data center 120 or computing device 132 at a central monitoring center 130 of FIG. 1).

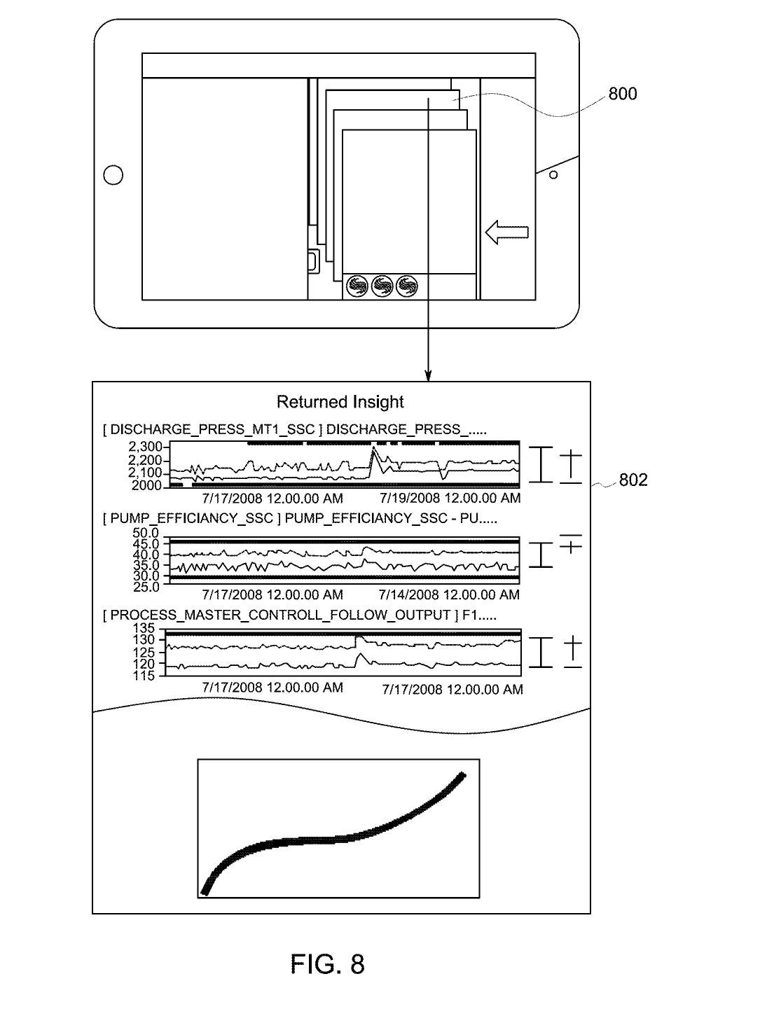

Referring now to FIG. 8, another content pane 800 includes a returned insight interface 802. The returned insight interface 802 presents a user with the information responsive to a user inquiry. The user inquiry may be, for example, a communication via the communication interface 602 of FIG. 6, or via the inquiry interface 702 of FIG. 7. For example, a user inquiry for operational ranges of a given pump on an offshore oil platform provided through the inquiry interface 702 of FIG. 7 may be answered by presenting one or more charts in the returned insight interface 802.

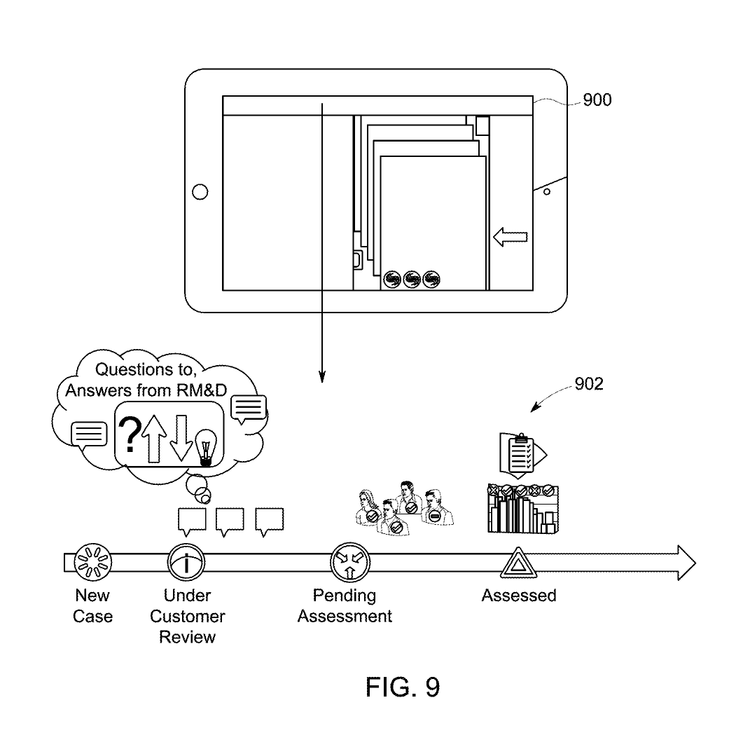

Referring now to FIG. 9, another content pane 900 includes a timeline interface 902. The timeline interface 902 provides a visual representation of the progression of a case threat. In some approaches, the timeline interface 902 also provides an indication of what personnel are involved with the case. In other approaches, the timeline interface 902 provides a visual representation of past assessments for similar problems and respective outcomes. In still other approaches, the timeline interface 902 provides an option to view recommendations.

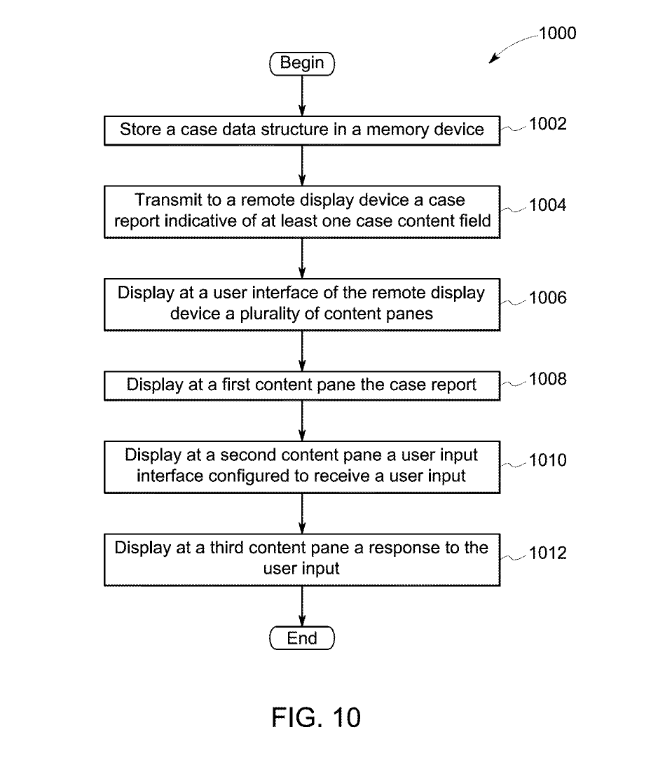

With reference to FIG. 10, a method 1000 includes storing 1002 a case data structure in a memory device. In some aspects, the case data structure is stored in a memory device at a central computing device at a central location (e.g., central monitoring center 130 of FIG. 1). In other aspects, the case data structure is stored in a memory device at a remote data center (e.g., data center 120 of FIG. 1). The case data structure represents characteristics of a case associated with an abnormality detected in an industrial machine or system. The case data structure comprising one or more case content fields.

The method 1000 further includes transmitting 1004, to a remote display device, a case report. The case report is indicative of at least one of the case content fields of a case data structure associated with an anomaly, an abnormality, or an incident detected in an industrial machine or system. The case report may also include information pertaining to past actions associated with the industrial machine or system.

The method 1000 further includes displaying 1006, at a user interface of the remote display device, a plurality of content panes. In this way, a user is able to evaluate the plurality of content panes in order to identify a course of action associated with the abnormality detected in the industrial machine or system. Two or more of the plurality of content panes can be viewed concurrently.

The method 1000 further includes displaying 1008, at a first content pane, the case report. Using this information, a user viewing the case report is able to efficiently assess the case.

The method 1000 further includes displaying 1010, at a second content pane, a user input interface configured to receive a user input. In some aspects, the user input interface includes a communication interface that enables communication between on-site personnel (e.g., personnel at operating site 110) and remote personnel (e.g., personnel at central monitoring center 130). The communication may be initiated by on-site personnel or remote personnel. The communication interface preferably presents a user with various user input options, such as an audio entry, a video entry, and/or free-form text entry. In this way, on-site personnel can efficiently communicate directly with personnel at a remote location through an “ask and receive” interface. In other aspects, the user input interface is includes an inquiry interface for self-service by the user. The inquiry interface presents a user with a prepopulated or predefined list of inquiries. For example, through the inquiry interface, a user may request technical drawings or other documentation pertaining to a given industrial machine, past work performed on the machine, past “like case” histories, troubleshooting guides, operating ranges, peer asset behavior comparisons, or “bad actor” flagging histories.

The method 1000 further includes displaying 1012, at a third content pane, a response to the user input. The response may be provided, for example, in a returned insight interface. The returned insight interface presents a user with the information responsive to a user inquiry.

In some approaches, the method further includes displaying, at a fourth content pane, a timeline interface. The timeline interface displays a timeline corresponding to the case data structure. In this way, the timeline interface provides a visual representation of the progression of a case threat.

In some aspects, the method further includes receiving a user input from the remote display device. The user input may be, for example, at least one of an audio input, a video input, a free-form text input, or a selected user input selected from a predefined list of user inputs. In some approaches, in response to receiving the user input from the remote display device, the method further includes transmitting a response to the user input to the remote display device.

In some approaches, the method further includes displaying the plurality of content panes at user interfaces of a plurality of remote display devices.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. An apparatus comprising:
a network interface with an input and an output;
a display device comprising a touch-sensitive user interface; and
a processor coupled to the network interface and the display device, the processor configured to display at the display device a first content pane, a second content pane, and a third content pane thereby allowing a user to evaluate the plurality of content panes in order to identify a course of action associated with the abnormality detected in the industrial machine or system;
wherein the first content pane comprises a case report received at the input of the network interface, the case report representing characteristics of a case associated with an abnormality detected in an industrial machine or system;
wherein the second content pane comprises a user input interface configured to receive a user input; and
wherein the third content pane comprises a response to the user input, the response received at the input of the network interface.

2. The apparatus of claim 1, wherein the user input is a free-form text entry, and wherein the processor is configured to transmit the free-form text entry to a central computing device at a central location.

3. The apparatus of claim 1, wherein the user input is an audio entry, and wherein the processor is configured to transmit the audio entry to a central computing device at a central location.

4. The apparatus of claim 1, wherein the user input is a video entry, and wherein the processor is configured to transmit the video entry to a central computing device at a central location.

5. The apparatus of claim 1, wherein the user input is selected from a predefined list of user inputs, and wherein the processor is configured to transmit via the output the selected user input to a central computing device at a central location.

6. The apparatus of claim 1, wherein each of the plurality of content panes are defined by a display width and a display height, and wherein at least one of the display width and the display height of at least one of the plurality of content panes is configured to be modified by a user input at the touch-sensitive user interface of the display device.

7. The apparatus of claim 1, wherein the processor is configured to display at the display device fourth content pane, wherein the fourth content pane comprises a timeline, the timeline received at the input of the network interface.

8. A method comprising:
storing a case data structure in a memory device, the case data structure representing characteristics of a case associated with an abnormality detected in an industrial machine or system, the case data structure comprising one or more case content fields;
transmitting to a remote display device a case report indicative of at least one of the case content fields;
displaying at a user interface of a remote display device a plurality of content panes thereby allowing a user to evaluate the plurality of content panes in order to identify a course of action associated with the abnormality detected in the industrial machine or system;
wherein the displaying comprises:
at a first content pane, displaying the case report;
at a second content pane, displaying a user input interface configured to receive a user input; and
at a third content pane, displaying a response to the user input.

9. The method of claim 8, wherein the displaying further comprises:
at a fourth content pane, displaying a timeline corresponding to the case data structure.

10. The method of claim 8, wherein the case data structure is stored in a memory device at a central computing device at a central location.

11. The method of claim 8, wherein the case data structure is stored in a memory device at a remote data center.

12. The method of claim 8, further comprising:
receiving a user input from the remote display device, the user input comprising at least one of an audio input, a video input, a free-form text input, or a selected user input selected from a predefined list of user inputs.

13. The method of claim 12, further comprising:
in response to receiving the user input from the remote display device, transmitting a response to the user input to the remote display device.

14. The method of claim 8, further comprising:
displaying the plurality of content panes at user interfaces of a plurality of remote display devices.
